(19) United States
(12) Patent Application Publication
(10) Pub. No.: US 2026/0044827 A1
(43) Pub. Date: Feb. 12, 2026

(54) SYSTEM FOR AUTOMATING DATA COLLECTION, PROCESSING, AND ANALYSIS FOR MONITORING, REPORTING, AND VERIFICATION (MRV) OF SUSTAINABILITY PROJECTS

(71) Applicant: Spiro Carbon Group Inc, Park City, UT (US)

(72) Inventors: Ahmed Mahgoub, Roswell, GA (US); Benjamin Worley, Alpharetta, GA (US)

(73) Assignee: Spiro Carbon Group Inc, Park City, UT (US)

(21) Appl. No.: 18/800,217

(22) Filed: Aug. 12, 2024

(51) Int. Cl. G06Q 10/10; G06V 10/32; G06V 10/60; G06V 10/74; G06V 10/94; G06V 20/10; G06V 20/13; G06V 20/50

(52) U.S. Cl. CPC G06Q 10/103; G06V 10/32; G06V 10/60; G06V 10/74; G06V 10/945; G06V 10/95; G06V 20/13; G06V 20/188; G06V 20/194; G06V 20/50

(57) ABSTRACT

This disclosure presents a system and method for automating the monitoring, reporting, and verification (MRV) of sustainability projects. The system includes a mobile application for users to submit data and images, which are transmitted to a cloud-based storage system. Metadata from the images is extracted and validated against predefined coordinates. A computer vision algorithm evaluates the images, and results are stored in a cloud-based database. The system further includes a secondary verification module using remotely sensed imagery. This automated and distributed approach reduces the cost, complexity, and time of MRV processes, enhancing transparency, reliability, and accuracy. The method supports scalability across diverse sustainability projects, including regenerative agriculture, biodiversity, and greenhouse gas reduction, by leveraging integrated data collection, automated analysis, and distributed network validation.

### FIELD OF THE INVENTION

The present invention relates to systems and methods for automating the monitoring, reporting, and verification (MRV) processes in projects focused on sustainability, regenerative agriculture, biodiversity, and greenhouse gas reduction. The invention addresses the limitations of traditional MRV methods by reducing costs, complexity, and time while increasing the scalability, reliability, and accuracy of the data and results.

### BACKGROUND

The importance of sustainability projects in addressing global environmental challenges cannot be overstated. Projects focused on regenerative agriculture, biodiversity preservation, and greenhouse gas reduction play a critical role in mitigating climate change, protecting ecosystems, and promoting sustainable land use practices. However, the traditional MRV processes associated with these projects often pose significant barriers.

Traditional MRV involves project developers or other individuals providing written attestations of the activities required under the chosen methodology for a particular project. An independent third party, sometimes referred to as a validation and verification body (VVB), conducts an audit of the received data, often requiring a physical inspection. This manual method results in added cost, complexity, and time, which can limit the feasibility of many projects, especially those with significant geographic dispersion.

The high cost associated with manual MRV processes often makes it challenging for small-scale and community-driven projects to participate. These projects, which may include smallholder farms or local conservation efforts, are crucial for widespread environmental impact but are frequently excluded due to financial constraints. Furthermore, the complexity and time-consuming nature of manual MRV processes can deter participation from groups lacking technical expertise or resources, thus limiting the diversity and inclusivity of sustainability efforts.

In an attempt to address these challenges, some solutions have relied solely on remote sensing methods to provide MRV. While remote sensing offers promising capabilities, such as the use of electro-optical, multispectral, and synthetic aperture radar imaging systems from unmanned, aerial, and space-based platforms, it also has significant limitations. The spatial, spectral, and temporal resolution constraints inherent with current remote sensing platforms mean that it cannot be guaranteed that the appropriate sensor will be in the right place at the right time to collect the required data. The spatial resolution requirements for measuring certain project variables are too high for commercial platforms, while weather, clouds, and other environmental factors can disrupt, distort, or deny data collection when and where needed. Consequently, relying solely on remote sensing can lead to gaps in data, reducing the reliability and accuracy of MRV results.

The proposed invention overcomes these limitations by utilizing a distributed ground-based data collection and automated analysis process while allowing for the integration of remote sensing when possible. This hybrid approach ensures robust data verification, reduces costs, and simplifies the MRV process, making sustainability projects more accessible and feasible for a broader range of participants.

### SUMMARY

The present disclosure describes a system and method for automating the monitoring, reporting, and verification (MRV) of sustainability projects, reducing the cost, complexity, and time associated with traditional manual methods. The system utilizes a mobile application for users to submit project data, including images with geolocation metadata, which is then validated and analyzed using cloud-based storage and computer vision algorithms.

This approach overcomes the limitations of remote sensing methods by integrating on-ground data collection, ensuring higher accuracy and reliability. By automating data processing and leveraging distributed data collection, the system enables scalable MRV across diverse projects in sustainability, regenerative agriculture, biodiversity, and greenhouse gas reduction, enhancing transparency and efficiency.

Exemplary arrangement mays provide a system for automating the monitoring, reporting, and verification (MRV) of sustainability projects. The exemplary system may include a mobile application configured to allow a user to submit project data, the project data may include images of specified objects corresponding to project variables. The system may further include a cloud-based storage system for receiving and storing the submitted data and images. The system may further include an automated analysis module configured to extract metadata from the submitted images including geolocation data, compare the extracted geolocation data with predefined project coordinates to validate the image location, evaluate the images using computer vision algorithms to determine compliance with predetermined project methodology requirements, and a database for storing the results of the automated analysis, the results may include numeric designations, image filenames, and file paths.

In alternative exemplary arrangements, the mobile application is further configured to allow the user to select characteristics from a pre-filled list describing the content of the image, serving as the user's attestation, identify the field or location where the image was taken, and transmit the image and selected data via a network to the cloud-based storage system.

In alternative exemplary arrangements, the automated analysis module is further configured to assign a numeric designation corresponding to the computer vision evaluation results, calculate additional derivative data required by the project methodology, and store the calculated derivative data in the cloud-based database.

In alternative exemplary arrangements, the secondary verification module is further configured to collect remotely sensed imagery via an API, communicate the collected imagery to the cloud-based server, clip the imagery to the project's geospatial boundaries, analyze the clipped imagery using automated image analysis techniques to compute surface reflectance values and other relevant metrics, and store the results of the secondary analysis in the cloud-based database.

In alternative exemplary arrangements, the secondary verification module is further configured to compare the results of the secondary analysis with the results from the automated analysis module, generate an alert if a discrepancy is found between the secondary analysis and the primary data source, and transmit the alert to the verification body responsible for performing verification.

In alternative exemplary arrangements, the computer vision algorithm applied by the automated analysis module is configured to determine if the submitted images meet the project methodology's requirements, identify conditions represented in the images.

In alternative exemplary arrangements, the exemplary system may further comprise a non-fungible token (NFT) generation module configured to create a digital representation of the MRV results after the MRV process is concluded. All project information, supporting data, data sources, and results are written to the NFT, and the NFT is minted onto a distributed ledger system to create a permanent, immutable record of the MRV results.

Alternative exemplary arrangements provide, a method for automating the monitoring, reporting, and verification (MRV) of sustainability projects. The method may include submitting project data and images using a mobile application deployed on a distributed data capture device. The method may further include transmitting the submitted project data and images to a cloud-based storage system. The method may further include extracting metadata from the submitted images including geolocation data. The method may further include comparing the extracted geolocation data with predefined project coordinates to validate the image location. The method may further include evaluating the images using computer vision algorithms to determine compliance with project methodology requirements. The method may further include storing the results of the automated analysis in a cloud-based database, the results may include numeric designations, image filenames, and file paths, in a cloud-based database. The method may further include using remotely sensed imagery for additional verification, including collecting, downloading, clipping, and analyzing the imagery. The method may further include comparing results of the remote sensing analysis with results of the automated analysis stored in a cloud-based database and generating alerts for discrepancies.

In alternative exemplary arrangements, the mobile application is further configured to allow the user to select characteristics from a pre-filled list describing the content of the image, identify the field or location where the image was taken, and transmit the image and selected data via a network to the cloud-based storage system.

In alternative exemplary arrangements, the method may further include calculating additional derivative data required by the project methodology during the automated analysis and storing the calculated derivative data in the cloud-based database

In the exemplary method, the remotely sensed imagery used for secondary verification may include electro-optical, multispectral, hyperspectral, synthetic aperture radar, and thermal data from unmanned, aerial, or space-based platforms.

In alternative exemplary arrangements, the method may further include generating an alert if a discrepancy is found between the results of the remote sensing analysis and the primary data source results, and transmitting the alert to a verification body responsible for performing verification.

In alternative exemplary arrangements, the method may further include creating a digital representation of the MRV results using a non-fungible token (NFT) after the MRV process is concluded. All project information, supporting data, data sources, and results are written to the NFT, and the NFT is minted onto a distributed network system to create a permanent, immutable record of the MRV results.

Alternative exemplary arrangements may provide, a non-transitory computer-readable storage medium storing executable instructions that, when executed by a processor, cause the system to perform a method for automating the monitoring, reporting, and verification (MRV) of sustainability projects. The method may include submitting project data and images using a mobile application deployed on a distributed data capture device. The method may further include transmitting the submitted project data and images to a cloud-based storage system. The method may further include extracting metadata from the submitted images, including geolocation data. The method may further include comparing the extracted geolocation data with predefined project coordinates to validate the image location. The method may further include evaluating the images using computer vision algorithms to determine compliance with project methodology requirements. The method may further include storing the primary data source, wherein the primary data source includes results of the automated analysis, wherein the results include numeric designations, image filenames, and file paths, in a cloud-based database. The method may further include using remotely sensed imagery for additional verification, including collecting, downloading, clipping, and analyzing the imagery. The method may further include comparing the results of the remote sensing analysis with the primary data source results and generating alerts for discrepancies.

In alternative exemplary arrangements, the mobile application is further configured to allow the user to select characteristics from a pre-filled list describing the content of the image, identify a field or location where the image was taken, and transmit the image and selected data via a network to the cloud-based storage system.

In alternative exemplary arrangements, the instructions further cause the system to calculate additional derivative data required by the project methodology during the automated analysis, and store the calculated derivative data in the cloud-based database.

In alternative exemplary arrangements, the remotely sensed imagery used for secondary verification may include electro-optical, multispectral, hyperspectral, synthetic aperture radar, and thermal data from unmanned, aerial, or space-based platforms.

In alternative exemplary arrangements, the instructions further cause the system to generate an alert if a discrepancy is found between the results of the remote sensing analysis and the primary data source results, and transmit the alert to a verification body responsible for performing verification.

In alternative exemplary arrangements, the instructions further cause the system to create a digital representation of the MRV results using a non-fungible token (NFT) after the MRV process is concluded. All project information, supporting data, data sources, and results are written to the NFT, and the NFT is minted onto a distributed ledger system to create a permanent, immutable record of the MRV results.

In alternative exemplary arrangements, the system may further include a secondary verification module configured to use remotely sensed imagery for additional verification. The remotely sensed imagery includes electro-optical, multispectral, hyperspectral, synthetic aperture radar, and thermal data from unmanned, aerial, or space-based platforms.

### BRIEF DESCRIPTION OF THE DRAWINGS

Embodiments of the present disclosure are illustrated in the following drawings to facilitate a clear understanding of the principles of the invention and are not necessarily drawn to scale.

FIG. 1 is a drawing illustrating an example of the user interface of a mobile application deployed on a distributed data collection device according to various embodiments of the present disclosure.

FIG. 2 is a drawing of a network environment according to various embodiments of the present disclosure.

FIG. 3 is a flowchart illustrating the outline of a primary verification method performed by the MRV system according to various embodiments of the present disclosure.

FIG. 4 is a flowchart illustrating certain portions of the primary verification method performed by the MRV system according to various embodiments of the present disclosure.

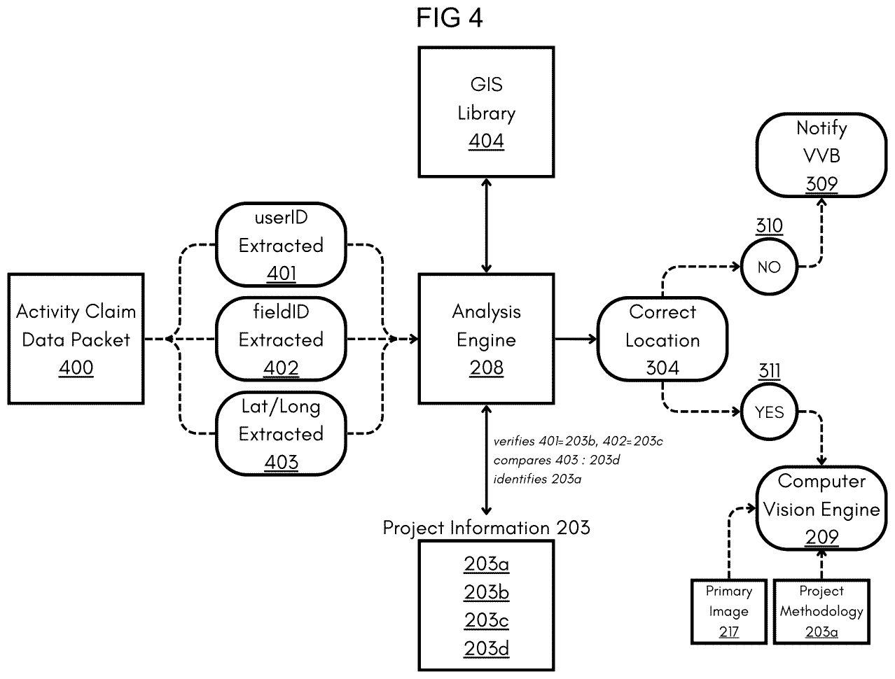

FIG. 5 is a flowchart illustrating the outline of a secondary verification method performed by the MRV system according to various embodiments of the present disclosure.

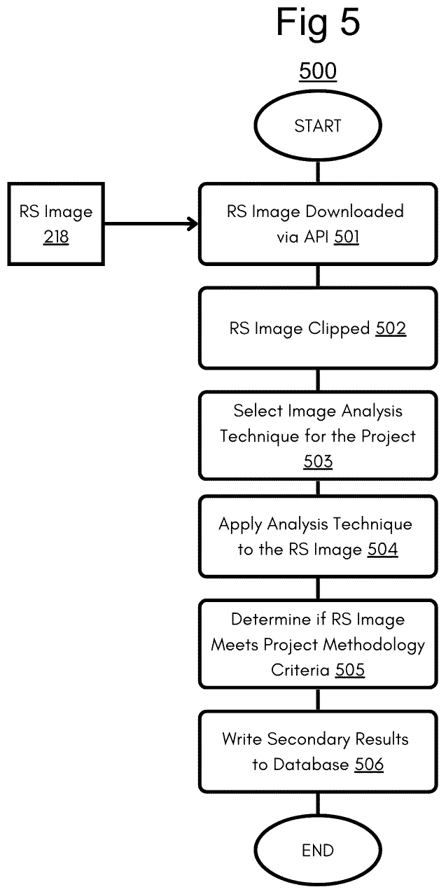

FIG. 6 is a schematic block diagram that provides one example illustration of a computing environment employed in the network environment of FIG. 2 as part of a non-transitory computer-readable storage medium containing executable instructions according to various embodiments of the present disclosure.

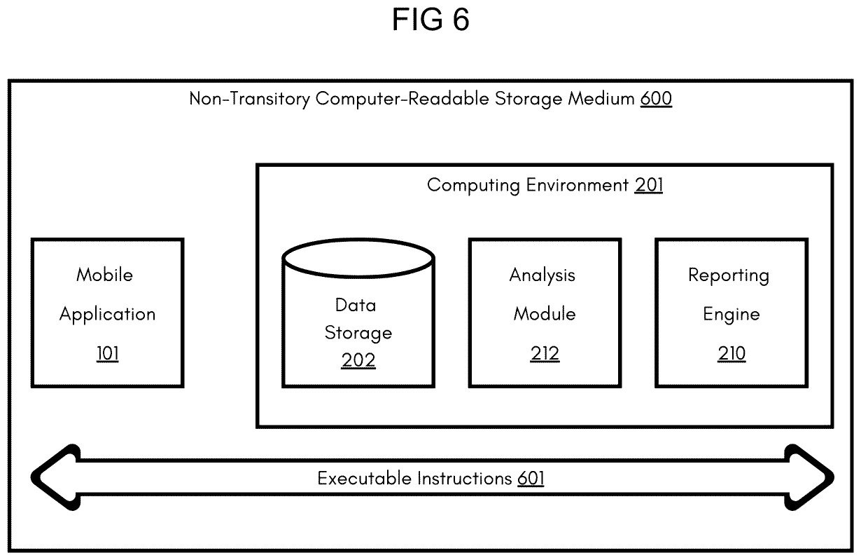

### DETAILED DESCRIPTION

In the following, a distributed, automated monitoring, reporting and verification (MRV) method, a distributed, automated MRV system, and a non-transitory computer-readable storage medium storing executable instructions, according to embodiments of the present disclosure, will be described. The present disclosure is not limited to the following embodiments. Identical components in the drawings on different figures or in different embodiments are assigned the same reference numerals.

For the purposes of the description, the term ‘user’ will be used to describe the farmer, landowner, employee, project developer, or any other project participant who is primarily responsible for submitting data and claims under project methodology guidelines in a sustainability project.

Various embodiments of the present disclosure encompass a system and method designed to automate the process of data collection, processing, and analysis for the purposes of MRV of projects related to sustainability, regenerative agriculture, biodiversity, or greenhouse gas reduction. Traditionally, MRV has involved the project developer or other project members providing written attestations of the activities required under the chosen methodology for a particular project. An independent third party, known as a validation and verification body (VVB), then conducts an audit of the received data. This manual method results in added cost, complexity, and time, which can limit the feasibility of many projects. The disclosed system significantly reduces the cost, complexity, and time required for MRV while increasing the transparency, reliability, and accuracy of the data and results through automation.

Most project types require the measurement and reporting of multiple variables to accurately calculate the activity's impact or effect. Some of these variables can be measured and verified using remote methods such as electro-optical, multispectral, and synthetic aperture radar imaging systems from unmanned, aerial, and space-based platforms. However, not all variables can be consistently or accurately measured from remote sources alone due to spatial, spectral, and temporal resolution constraints, as well as environmental factors like weather and clouds. In some embodiments, these remote sensing and automated analysis techniques are used in conjunction with the invention method to measure and verify other variables required in the project methodology or as a secondary source of confirmatory verification where the invention acts as the primary source. The advantage of the invention over remote sensing platforms is its immunity to these limitations.

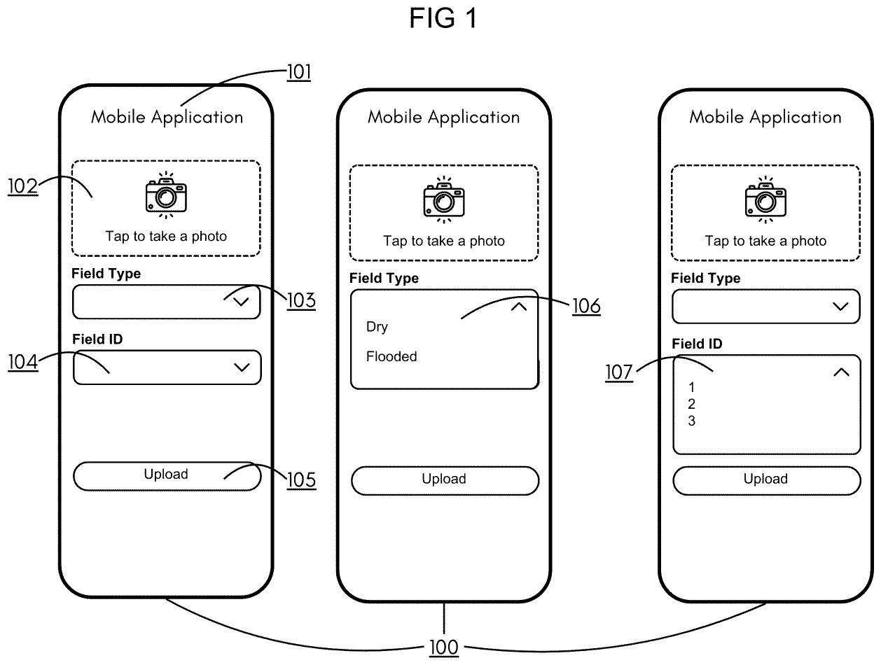

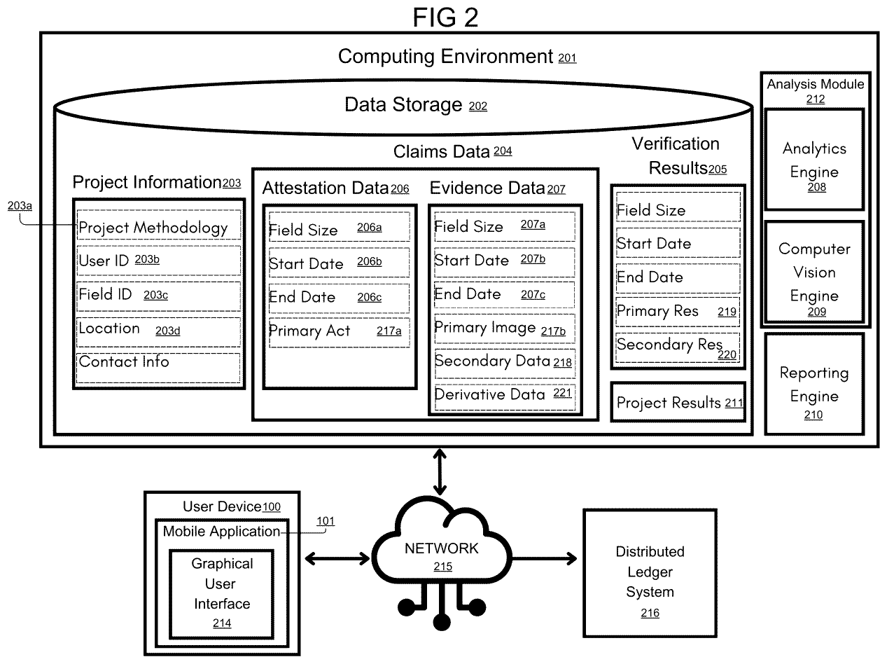

The system has a mobile application 101 installed on a distributed data collection device 100, various embodiments of which may include devices such as smartphones, tablets, wearable devices like smartwatches, smart glasses, handheld scanners, or any portable electronic device capable of collecting, processing, and transmitting data, that the user employs to submit relevant data for the project, which is then corroborated by automated analysis and, in some embodiments, a secondary data source. The system comprises several key components:
Mobile Application 101: Used by the user to submit project-related data 206, also referred to attestation data 206, including images 217b, by interacting with a graphical user interface 214.
Cloud-Based Storage System 202: Receives and stores static project information 203, all claims related data 204 including user submitted data 206 and images 217b, and derivative data 221 and secondary collected data 218, and all verification results 205 and project reporting data 211, also referred to as project result 211.
Automated Analysis Module 212: Performs metadata extraction, geolocation validation, and computer vision analysis.
Distributed Ledger System 216: Stores analysis results, image filenames, and file paths as a comprehensive report.
Secondary Verification: Utilizes remotely sensed imagery for additional verification.
Mobile Application and Data Submission: In one exemplary embodiment, as shown in FIGS. 1-2, in a first step 102 the user will use the mobile application 101 to take a photo or image of a specified object related to the variable to be measured in the project. In a second step 103 the user selects a characteristic from a pre-filled list of field types describing the character of the image 217b, this being their attestation or primary act 217a. In a fourth step 104, the user then selects the field ID or location identification for the specified location in which the image 217b was taken. In a fifth step 105, the user then submits the image through the application, which transmits the data via a cellular or other network 215 connected to the internet. However, this embodiment is exemplary, and other embodiments, system processes, or configurations may be used.

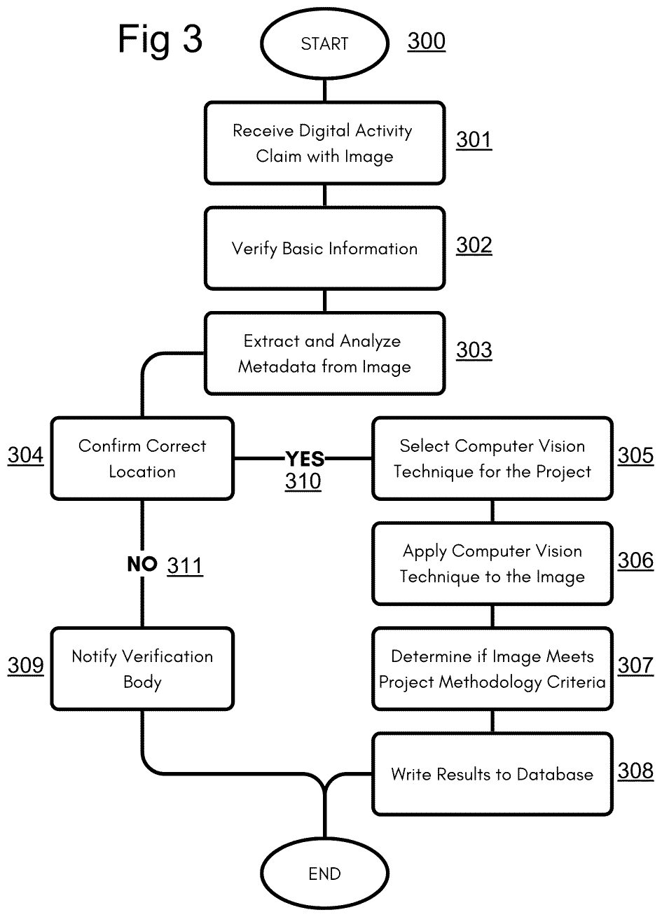

In alternative embodiments, as shown in FIGS. 2-3, the image 217b is transmitted via step 301 to a cloud-based storage system 202 as part of an activity claim data packet 400 where the basic project information 203 of the received data packet 400 is extracted, including the user's unique identification data 401 (user ID), the field or project location's unique identification data 402 field ID, and the geolocation data or coordinates including latitude and longitude data at which the image 217b was taken 403. At step 303 the geolocation data and coordinates are extracted from the image's 217b metadata. Project information 203 gathered during a process executed prior to the commencement of the method of this invention, whereby project-specific data is collected from the user in various formats for the purpose of onboarding the user or a user's project to a system in preparation for the application of the method of this invention, an exemplary embodiment of which is a digital text application which requires the user to provide geospatial boundaries for the project from which a center point is determined and the coordinates of that center point is saved to a project information 203 table on a data storage 202 device, referenced as location 203d. During the onboarding process, an alphanumeric identification is generated and assigned to the user, referenced in FIG. 2 as user ID 203b and an alphanumeric identification is generated and assigned to the location 203d, referenced in FIG. 2 as field ID 203c. At step 302, the extracted information is verified by an analytics engine 208 against pre-existing project information 203 whereby the extracted user ID data 401 is verified against user ID data 203b and the extracted field ID data 402 is verified against the field ID data 203c. The analytics engine 208 then compares the extracted coordinates 403 with the coordinates of the center point of the field or other project location 203d as listed in the project information 203 lookup table on the cloud-based data storage 202, which was created during the project's initial onboarding, using a geographical information systems (GIS) library reference 404. If the system determines 310 that the coordinates 403 are within a specified radius of the field's fixed coordinates 203d, the image 217b is considered valid and is passed to the next step. If they are not in range via a system determination 311, then a notice to the verification body is automatically generated and sent 309. Of course, this embodiment is exemplary, and other embodiments, system processes, or configurations may be used.

Automated Analysis: In the next step 305, a computer vision algorithm, various embodiments of which may include the application of a single or a combination of techniques such as Convolutional Neural Networks, Vision Transformers or other techniques as may be required, is chosen based on the relevant project methodology 203a. At step 306, the computer vision algorithm is executed. At step 307, the system evaluates and determines whether the image 217b represents conditions in line with the requirements of the project methodology 203a. A numeric designation, an example of which is a 0, 1, or 2 if the results of analysis are ‘true’, ‘false’ or ‘error’ respectively, although this embodiment is exemplary and other embodiments, values and configurations may be used, is assigned based on the computer vision evaluation results 219, and at step 308, that value is written to a table on a cloud-based database referenced in FIG. 2 as verification results 205. The image filename and file path to where the image is digitally stored is also written to the database.

In alternative embodiments, an additional step of calculating derivative data 221 required to fulfill that section of the project methodology is included in the system methods and processes. In those cases, the derivative data 221, once calculated by the system, is written to a table for results 205 on a cloud-based database.

Secondary Verification: In alternative embodiments, the conclusion of the computer vision analysis process 306 automatically triggers a secondary verification process 500. In such embodiments, the secondary source of data is remotely sensed imagery 218 of various types, including electro-optical, multispectral, hyperspectral, synthetic aperture radar, and thermal from unmanned, aerial, or space-based platforms. However, these are merely examples of remotely sensed imagery, and other methods or systems may be used.

When initiated, the process 500 engages a third-party system for imagery collection via an application programming interface (API). In a first step 501, the image is downloaded to the cloud-based server 202. In a second step 502, the image is clipped to the geospatial boundaries of the project. In a third step 503, the relevant analysis method is selected based on the project methodology 203a. In a fourth step 504, the image is analyzed using an automated process of image analysis. This image analysis may take several forms depending on the required variable for measurement but in all cases includes at least the examination and computation of surface reflectance values as represented numerically in each pixel of the digital image executed through a standard analytics engine 208 or a computer vision engine 209 depending on the analysis type applied at step 504. In various embodiments, the surface reflectance values may be further analyzed to calculate other relevant metrics through the application of various indices which apply individual surface reflectance pixel values of various bands of the electromagnetic spectrum to a relevant equation in order to calculate a derivative value. An example of this may be Normalized Difference Vegetation Index (NDVI) wherein the numeric value of the near-infrared (NIR) band, commonly understood to encompass those wavelengths between 700 and 1,400 nanometers, and the red (RED) band, commonly understood to encompass those wavelengths between 601 and 700 nanometers, wherein the surface reflectance values of each are applied to the equation NIR−RED/NIR+RED. An application of NDVI is only an example and other indices or combinations of reflectance values may be applied to achieve the relevant metrics, examples of which may include the presence or absence of vegetation, water or other materials. These are examples only and the relevant metrics may include other characteristics as defined by the project methodology to which the project belongs. At step 505, the analysis output is evaluated against the project methodology 203a to determine if it meets the criteria. At step 506, the results 220 of the analysis are written to a cloud-based database 202. Of course, this embodiment is exemplary, and other embodiments, system processes, or configurations may be used.

Discrepancy Alerts and Reporting: These secondary results 220 are also compared with the results 219 from the primary data source. If no discrepancy is found, the system process is allowed to proceed. If a discrepancy is found between the two data sources, an alert is generated and transmitted via electronic means to the verification body for the project. The verification body is the entity responsible for performing verification, as described in various embodiments in ISO 17029:“Conformity assessment—General principles and requirements for validation and verification bodies”, the document outlining general principles and requirements for the competence, consistent operation and impartiality of bodies performing validation and verification conformity assessment activities as published by the International Organization of Standardization, or other such recognized authorities as may be relevant to the project. Validation and verification are understood to be a confirmation of reliability of information declared in claims.

If no discrepancy is found and all requirements from the project methodology 203a have been met through the collection and analysis of corresponding data, the system applies the measurements from each of those variables to the project methodology. The full results 211 are then written to a report conforming to the user's requirements by a reporting engine 210. One embodiment of the disclosure includes the process of the reporting engine 210 transmitting the report details to a distributed ledger system 216 via a network connection 215 through the process of minting a non-fungible token (NFT) wherein all project data and results are included. This NFT acts as a permanent, immutable record of the claim, verification and results of the project. However, this embodiment is exemplary, and other embodiments, system processes, and configurations may be used.

Non-Transitory Computer-Readable Storage Medium 600: A non-transitory computer-readable storage medium 600 stores executable instructions 601 that, when executed by a processor, cause the system to perform the system processes, operations, functions, and methods described. These instructions 601 enable the mobile application 101 to submit data 206, the cloud-based storage system 202 to receive and store data, the automated analysis module 212 to extract and analyze metadata, the secondary verification module 500 to perform additional verification using remotely sensed imagery 218, and the reporting engine 210 to generate and publish the required reports. The storage medium 600 ensures that all components of the system work together seamlessly to automate the MRV process. Of course, this storage medium is exemplary, and in other embodiments and configurations, other storage mediums may be used.

### Example Embodiment: Methane Reduction in Rice Cultivation

An example embodiment of the invention may be used for a project involving methane reduction in rice cultivation. Traditional rice cultivation using flooded fields or “paddies” results in the emission of significant amounts of methane due to the process of anaerobic decomposition of organic matter in the soil. The implementation of the farming technique alternate wetting and drying (AWD) can reduce methane emissions.

The methodology for quantifying methane reduction from rice paddies which implements the practice of AWD requires three variables be measured: (a) the size of the area under cultivation in hectares, (b) the duration of the cultivation from seeding to harvest in days, and (c) the emissions factor which is calculated based on the number of dry-down periods, or periods where the paddy is dried to a depth of 15 cm below the surface before being reflooded.

In this embodiment, the user is the rice farmer who submits planting 206b and harvest dates 206c through the mobile application 101. These are a digital form of the farmer's attestations 206 for variable (b) as the duration of cultivation is calculated through simple subtraction and verified using multispectral satellite imagery with the application of a common vegetation index and basic pixel analysis. This analysis creates an independent source of data 207 validating the planting date 207b and harvest date 207c.

Variable (a) is satisfied through the attestation of the user during the project onboarding when the user declares the project's geospatial boundaries 206a and a vector file for use on GIS is created and saved in the system's memory. That attestation is verified through the use of multispectral satellite imagery with the application of a common vegetation index and basic pixel analysis 207a midway through the cultivation period.

Variable (c), the emissions factor, represents the part of the project methodology addressed by the process claimed in this invention. In this embodiment, at step 102, the user employs the mobile application 101 to take a photo of the field, specifically aligning the pani pipe in the frame, showing the field is flooded. The pani pipe is a small pipe, typically made from PVC, around 6 inches in diameter and 12 inches in length, that is buried halfway in the ground, which allows the user to see the water level below the ground surface. At step 106, the user selects whether the field is flooded or dried, this being their attestation 217a, and then at step 107 selects the field identification for the specified field in which the image 217b was taken. At step 105, the user then submits the image 217b and attestation 217a through the application 101, which transmits the data via a cellular or other network 215 connected to the internet.

This image 217b is sent to a cloud-based storage system 202 and triggers a process 300 to verify the primary activity claim 217a. When the user submits at step 105 the pani pipe image 217b with the dry or flooded designation at step 106 (their attestation 217a) and the field identification selection at step 107, the executable instructions 601 command the application 101 to send the combined data packet 206, which includes other embedded data such as the ser ID 203b to the computing environment 201. In this example embodiment, the computing environment 201 is a cloud-based configuration of elastic servers, digital storage and structured databases. This data packet is received at step 301 and the non-transitory computer-readable storage medium 600 storing the executable instructions 601 initiates a comparison between the user ID data 401 and field ID data 402 from the data packet 400 to those corresponding values hosted on a database 203 in the data storage 202 to ensure the results will be posted to the correct project when reported. At step 302, the verification is complete 302, the process then extracts the metadata from the image 217b, specifically extracting the geolocation data or coordinates at step 403 at which the image 217b was taken. The system compares at step 304 these coordinates from step 403 with the coordinates of the center point of the field 203d as listed in a separate lookup table 203 created during the project's initial onboarding. If the coordinates from step 403 are within a specified radius, in this example 1 km, of the field's fixed coordinates 203d, determined through the application of a python script running on an analytics engine 208 using a GIS library 404, the image 217b is considered valid at step 310 and is passed to the next step.

Because the project methodology in this example requires determining the emissions factor based on the act, quantity and timing of dry and flood periods, a specific computer vision technique is automatically selected at step 305. A computer vision algorithm is applied at step 306 to the image 217b to determine if it represents conditions that are flooded, dry, or if the image does not meet either of these criteria due to user error, poor quality, or any other reason at step 307. A designation of 0, 1, or 2 is given based on those criteria, and the results are written at step 308 to a cloud-based database 219. The image filename and file path are also written to the database 211.

In a typical scenario, the user will submit three to five flooded images and one to two dry images in an alternating pattern of flood, dry, flood. Because so much rice cultivation is done on very small farms, this ability to use a distributed data collection and automated analysis process for MRV greatly reduces the cost, complexity, and time associated with traditional MRV, making these small and micro projects cost feasible. These flood/dry cycles can last for as little as two days, making it often challenging to capture the activity by means of remote sensing. By putting the primary source of data on the ground with the project, it removes the risks of missed verification due to environmental, technical, or timing conditions when MRV relies solely on remote sensing. By shifting the evidentiary support portion of the MRV process to a distributed network of the entire user base in a project, covering every participating location, and maintaining strict integrity over data chain of custody, geographic dispersion becomes a non-issue. This automated and distributed approach streamlines MRV processes, reducing time, cost, and complexity, and enhancing the transparency, reliability, and accuracy of data across diverse projects related to sustainability, regenerative agriculture, biodiversity, and greenhouse gas reduction.

1. A system for automating the monitoring, reporting, and verification (MRV) of sustainability projects, comprising:
a mobile application configured to allow a user to submit project data, wherein the project data includes images of specified objects corresponding to project variables;
a cloud-based storage system for receiving and storing the submitted data and images;
an automated analysis module configured to:
extract metadata from the submitted images, wherein the metadata includes geolocation data;
compare the extracted geolocation data with predefined project coordinates to validate the image location;
evaluate the images using computer vision algorithms to determine compliance with predetermined project methodology requirements;
a database for storing the results of the automated analysis, wherein the results include numeric designations, image filenames, and file paths.

2. The system of claim 1, wherein the mobile application is further configured to allow the user to:
select characteristics from a pre-filled list describing the content of the image, serving as the user's attestation;
identify the field or location where the image was taken;
transmit the image and selected data via a network to the cloud-based storage system.

3. The system of claim 1, wherein the automated analysis module is further configured to:
assign a numeric designation corresponding to the computer vision evaluation results;
calculate additional derivative data required by the project methodology;
store the calculated derivative data in the cloud-based database.

4. The system of claim 1, further comprising:
a secondary verification module configured to use remotely sensed imagery for additional verification, wherein the remotely sensed imagery includes electro-optical, multispectral, hyperspectral, synthetic aperture radar, and thermal data from unmanned, aerial, or space-based platforms,
wherein the secondary verification module is further configured to:
collect remotely sensed imagery via an API;
communicate the collected imagery to the cloud-based server;
clip the imagery to the project's geospatial boundaries;
analyze the clipped imagery using automated image analysis techniques to compute surface reflectance values and other relevant metrics;
store the results of the secondary analysis in the cloud-based database.

5. The system of claim 4, wherein the secondary verification module is further configured to:
compare the results of the secondary analysis with the results from the automated analysis module;
generate an alert if a discrepancy is found between the secondary analysis and the primary data source, and transmit the alert to the verification body responsible for performing verification.

6. The system of claim 1, wherein the computer vision algorithm applied by the automated analysis module is configured to:
determine if the submitted images meet the project methodology's requirements;
identify conditions represented in the images.

7. The system of claim 1, further comprising:
a non-fungible token (NFT) generation module configured to create a digital representation of the MRV results after the MRV process is concluded, wherein:
all project information, supporting data, data sources, and results are written to the NFT;
the NFT is minted onto a distributed ledger system to create a permanent, immutable record of the MRV results.

8. A method for automating the monitoring, reporting, and verification (MRV) of sustainability projects, comprising:
submitting project data and images using a mobile application deployed on a distributed data capture device;
transmitting the submitted project data and images to a cloud-based storage system;
extracting metadata from the submitted images, wherein the metadata includes geolocation data;
comparing the extracted geolocation data with predefined project coordinates to validate the image location;
evaluating the images using computer vision algorithms to determine compliance with project methodology requirements;
storing the results of the automated analysis in a cloud-based database, wherein the results include numeric designations, image filenames, and file paths, in a cloud-based database;
using remotely sensed imagery for additional verification, including collecting, downloading, clipping, and analyzing the imagery;
comparing results of the remote sensing analysis with results of the automated analysis stored in a cloud-based database and generating alerts for discrepancies.

9. The method of claim 8, wherein the mobile application is further configured to allow the user to:
select characteristics from a pre-filled list describing the content of the image;
identify the field or location where the image was taken;
transmit the image and selected data via a network to the cloud-based storage system.

10. The method of claim 8, further comprising:
calculating additional derivative data required by the project methodology during the automated analysis;
storing the calculated derivative data in the cloud-based database.

11. The method of claim 8, wherein the remotely sensed imagery used for secondary verification includes:
electro-optical, multispectral, hyperspectral, synthetic aperture radar, and thermal data from unmanned, aerial, or space-based platforms.

12. The method of claim 8, further comprising:
generating an alert if a discrepancy is found between the results of the remote sensing analysis and the primary data source results, and transmitting the alert to a verification body responsible for performing verification.

13. The method of claim 8, further comprising:
creating a digital representation of the MRV results using a non-fungible token (NFT) after the MRV process is concluded, wherein:
all project information, supporting data, data sources, and results are written to the NFT;
the NFT is minted onto a distributed network system to create a permanent, immutable record of the MRV results.

14. A non-transitory computer-readable storage medium storing executable instructions that, when executed by a processor, cause the system to perform a method for automating the monitoring, reporting, and verification (MRV) of sustainability projects, the method comprising:
submitting project data and images using a mobile application deployed on a distributed data capture device;
transmitting the submitted project data and images to a cloud-based storage system;
extracting metadata from the submitted images, including geolocation data;
comparing the extracted geolocation data with predefined project coordinates to validate the image location;
evaluating the images using computer vision algorithms to determine compliance with project methodology requirements;
Storing the primary data source, wherein the primary data source includes results of the automated analysis, wherein the results include numeric designations, image filenames, and file paths, in a cloud-based database;
using remotely sensed imagery for additional verification, including collecting, downloading, clipping, and analyzing the imagery;
comparing the results of the remote sensing analysis with the primary data source results and generating alerts for discrepancies.

15. The non-transitory computer-readable storage medium of claim 14, wherein the mobile application is further configured to allow the user to:
select characteristics from a pre-filled list describing the content of the image;
identify a field or location where the image was taken;
transmit the image and selected data via a network to the cloud-based storage system.

16. The non-transitory computer-readable storage medium of claim 14, wherein the instructions further cause the system to:
calculate additional derivative data required by the project methodology during the automated analysis;
store the calculated derivative data in the cloud-based database.

17. The non-transitory computer-readable storage medium of claim 14, wherein the remotely sensed imagery used for secondary verification includes:
electro-optical, multispectral, hyperspectral, synthetic aperture radar, and thermal data from unmanned, aerial, or space-based platforms.

18. The non-transitory computer-readable storage medium of claim 14, wherein the instructions further cause the system to:
generate an alert if a discrepancy is found between the results of the remote sensing analysis and the primary data source results, and transmit the alert to a verification body responsible for performing verification.

19. The non-transitory computer-readable storage medium of claim 14, wherein the instructions further cause the system to:
create a digital representation of the MRV results using a non-fungible token (NFT) after the MRV process is concluded, wherein:
all project information, supporting data, data sources, and results are written to the NFT;
the NFT is minted onto a distributed ledger system to create a permanent, immutable record of the MRV results.

20. The system of claim 1, further including:
a secondary verification module configured to use remotely sensed imagery for additional verification, wherein the remotely sensed imagery includes electro-optical, multispectral, hyperspectral, synthetic aperture radar, and thermal data from unmanned, aerial, or space-based platforms.
